(19) United States
(12) Patent Application Publication
(10) Pub. No.: US 2025/0367615 A1
(43) Pub. Date: Dec. 4, 2025

(54) PORTABLE MIXING SYSTEM FOR PRESSURIZED FLOW

(71) Applicant: BluRock Investments, LLC, Saxonburg, PA (US)

(72) Inventor: Michael A. Zock, Saxonburg, PA (US)

(21) Appl. No.: 19/228,097

(22) Filed: Jun. 4, 2025

Related U.S. Application Data
(60) Provisional application No. 63/655,763, filed on Jun. 4, 2024.

(51) Int. Cl. B01F 25/433; B01F 25/431; B01F 33/501; B01F 35/43; B01F 101/00

(52) U.S. Cl. CPC B01F 25/4331; B01F 25/4316; B01F 25/431971; B01F 33/5013; B01F 35/43; B01F 2101/305; B01F 2215/0431

(57) ABSTRACT

A portable mixing system for pressurized flow comprises a portable housing including a base supporting the system; a fluid inlet within the housing; a fluid outlet within the housing; a static mixer within the housing in fluid communication with the fluid inlet and the fluid outlet, the static mixer including a spiral pathway of piping extending to the fluid outlet, and wherein the portable mixing system may be moved as a single unit, has a footprint not greater than 5.5′×8′, has a weight less than 3000 lbs, and a total height less than 10′.

### RELATED APPLICATIONS

This application claims the benefit of U.S. Patent Application Ser. No. 63/655,763 filed Jun. 4, 2024, which is incorporated herein by reference in its entirety.

This application is related to the inventors work in U.S. Patent Application Ser. No. 63/589,808 filed Oct. 12, 2023 relating to a flow controlled rapid powder injection system for injection into a pressurized flow, such as, treatment of a stormwater, industrial effluent (e.g., AMD), and sedimentation pond and/or at the inlet of a portable settling tanks. See also U.S. Patent Publication 2025-0122104 which is a publication of a regular application claiming the benefit of U.S. Patent Application Ser. No. 63/589,808. The inventor was a co-inventor of that technology which may be coupled to the mixing system of the present invention, but forms no part of the mixing system of the present invention which is solely invented by Michael Zock.

### BACKGROUND OF THE INVENTION

### Field of the Invention

The present invention relates to a portable mixing system for a pressurized flow, such as, treatment of a stormwater, industrial effluent (e.g., AMD), and sedimentation pond and/or at the inlet of a portable settling tanks.

### Background Information

Mixing dry powder materials into a pressurized stream of fluid is needed in many environments. For example, in water treatment (in a portable settling tank or sedimentation pond) flocking agents may be desirable to improve settling and adding such material directly to the pond or within the settling portion of the tank is far less effective. In the settling tank context, it is desirable and even necessary to dose or treat the water before delivery to the settling tank portion of the system.

Traditionally, a venturi mixer, aka a venturi hopper or jet hopper, is used for similar application of dry ingredients to a stream of pressurized fluid. The venture hopper provides a simple means of mixing dry materials into liquids. A low-pressure area is created by increasing the flow velocity through the venturi nozzle. This low pressure draws the dry materials into the liquid stream where turbulent flow expedites the wetting process. The venture hopper however requires certain pressures to operate and cannot easily adjust dry material flow rates for distinct dosing requirements.

Mixing liquid materials into a pressurized fluid stream is needed in many environments analogous to the need for mixing dry powder materials. For example, flocking agents also are provided in a liquid format. Similarly, mixing dissolvable solid materials within a pressurized fluid stream is needed, as, for example, flocking agents are provided as a dissolvable solid. Solid includes semi-solids such as gel materials. As used herein, the introduction of solid material via a dissolvable solid is considered an injection of the solid material into the flow.

As noted above the mixer of the present invention may be considered as related to the inventors work as a co-inventor in U.S. Patent Application Ser. No. 63/589,808 filed Oct. 12, 2023 (U.S. Patent Publication 2025-0122104) relating to a flow controlled rapid powder injection system for injection into a pressurized flow, such as, treatment of a stormwater, industrial effluent (e.g., AMD), and sedimentation pond and/or at the inlet of a portable settling tanks. The inventor was a co-inventor of that technology which may be coupled to the mixing system of the present invention, but forms no part of the mixing system of the present invention.

As the present invention may have implementation within portable settling tanks, some background in this space is helpful and such background is provided within International Patent Application Serial Number PCT/US2021/062082 filed Dec. 6, 2021 and titled “Portable Settling Tank Configured for Use as a Sediment Control” which published Jun. 9, 2022 as WO 2022/120293. The present invention may be implemented with, and thus relates to, sedimentation tanks or settling tanks and the phrase “settling tank” or “sedimentation tank” will be used herein to define a tank holding liquid suspension therein until at least some of particles suspended within the liquid settles out. The phrase “sediment trap” will reference herein a settlement tank, or sedimentation tank, which is configured to capture sediment that is transported in land-based water runoff.

The present invention may be implemented with, and thus relates to, Settling or sedimentation ponds, Sediment basins, silt basins, industrial effluent controls, waste water control systems, namely anywhere where a portable fluid mixer for a pressurized flow.

There remains a need for effective efficient mixing of pressurized liquid streams with dry powder materials or liquid materials or dissolvable solid materials.

### SUMMARY OF THE INVENTION

One aspect of the present invention provides a portable mixing system for pressurized flow comprising a portable housing including a base supporting the system; a fluid inlet within the housing; a fluid outlet within the housing; a static mixer within the housing in fluid communication with the fluid inlet and the fluid outlet, the static mixer including a spiral pathway of piping extending to the fluid outlet, and wherein the portable mixing system may be moved as a single unit, has a footprint not greater than 5.5′×8′, has a weight less than 3000 lbs, and a total height less than 10′.

The portable mixing system according to one aspect of the invention may provide wherein the static mixer further includes a plurality of baffled segments, such as four, wherein each baffle segment includes at least one internal baffle member for creating and enhancing mixing within the flow. The static mixer may be effectively formed as a downward extending spiral of five loops and about 85′ pathway of 6″ diameter piping comprised of elbows, straight coupling segments and inserted baffled segments. The housing may include an internal frame and wherein the spiral pathway of piping wraps around the internal frame. One aspect of the invention provides that the spiral pathway of piping includes rectangular cross sectional piping.

The portable mixing system according to one aspect of the invention may provide wherein the base includes at least one set of fork pockets to facilitate movement of the system wherein each forklift pocket is an opening in the base through which a prong of a forklift is inserted. The housing may include a plurality of frame members and cross supports with panels attached thereto, and the housing may include lift points secured to the frame members or cross supports configured to allow for lifting of the system. The housing may include a roof assembly with the total height of the system being less than 8′.

The portable mixing system according one aspect of the invention may provide wherein the fluid inlet is generally horizontal and is fluidly coupled a generally vertical riser and wherein the fluid inlet has a cross sectional area less than the cross sectional area of the vertical riser. The portable mixing system according to one aspect of the invention may further include an air flow management subsystem coupled to the riser and including an air management unit configured to relieve excess air pressure that may occur within the system and to allow inputting air during shutdown or drainage of the system. The portable mixing system according to one aspect of the invention may provide wherein the air management unit is at the highest point of the fluid handling components of the system and wherein air will collect in an accumulator and will be episodically released as pressure reaches a release threshold. The portable mixing system according to one aspect of the invention may further include a top deck subsystem fluidly coupled to the riser and including at least one horizontal section fluidly coupled to the static mixer.

These and other aspects and advantages of the present invention will be described below in connection with the associated figures.

### BRIEF DESCRIPTION OF THE FIGURES

FIG. 1 is a front perspective partially exploded view of a portable high capacity mixing system for pressurized flow according to the present invention with two panels removed for clarity.

FIG. 2 is a rear perspective partially exploded view of the portable high capacity mixing system for pressurized flow according to FIG. 1.

FIG. 3 is a schematic view of a portion of the inlet and riser subsystem, as well as spatially illustrating baffle inserts of the static mixing subsystem, of the portable high capacity mixing system for pressurized flow according to FIG. 1.

FIG. 4 is a rear perspective view of a housing subsystem, with an internal frame and remaining subsystems omitted, of the static mixing subsystem of the portable high capacity mixing system for pressurized flow according to FIG. 1.

FIG. 5 is a schematic view of a portion of the inlet and riser subsystem of the portable high capacity mixing system for pressurized flow according to FIG. 1.

FIG. 6 is a schematic view of a flash mixing portion of the inlet and riser subsystem of the portable high capacity mixing system for pressurized flow according to FIG. 1.

FIG. 7 is a schematic view of an air flow management subsystem and a top deck subsystem of the portable high capacity mixing system for pressurized flow according to FIG. 1.

FIG. 8 is a schematic view of static mixer subsystem of the portable high capacity mixing system for pressurized flow according to FIG. 1.

FIG. 9 is a schematic view of inserted baffled segments of the static mixer subsystem of the portable high capacity mixing system for pressurized flow according to FIG. 1.

FIG. 10 is a schematic enlarged view of some of the inserted baffled segments of the static mixer subsystem of the portable high capacity mixing system for pressurized flow according to FIG. 1.

FIG. 11 is a schematic perspective view of alternative piping elements for the static mixer subsystem of the portable high capacity mixing system for pressurized flow according to FIG. 1.

### DESCRIPTION OF THE PREFERRED EMBODIMENTS

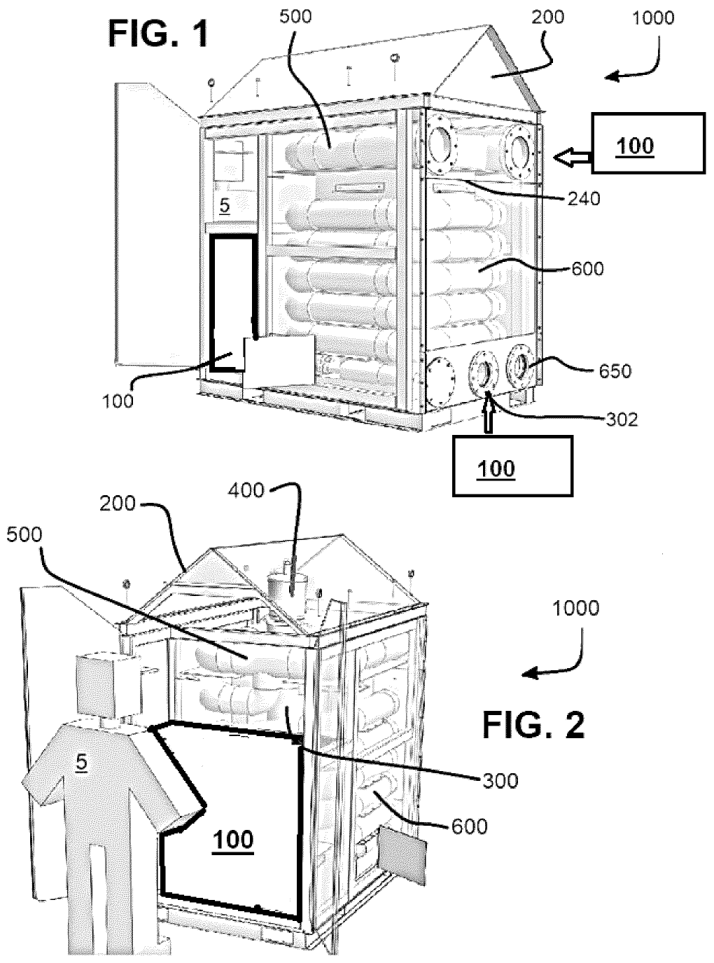

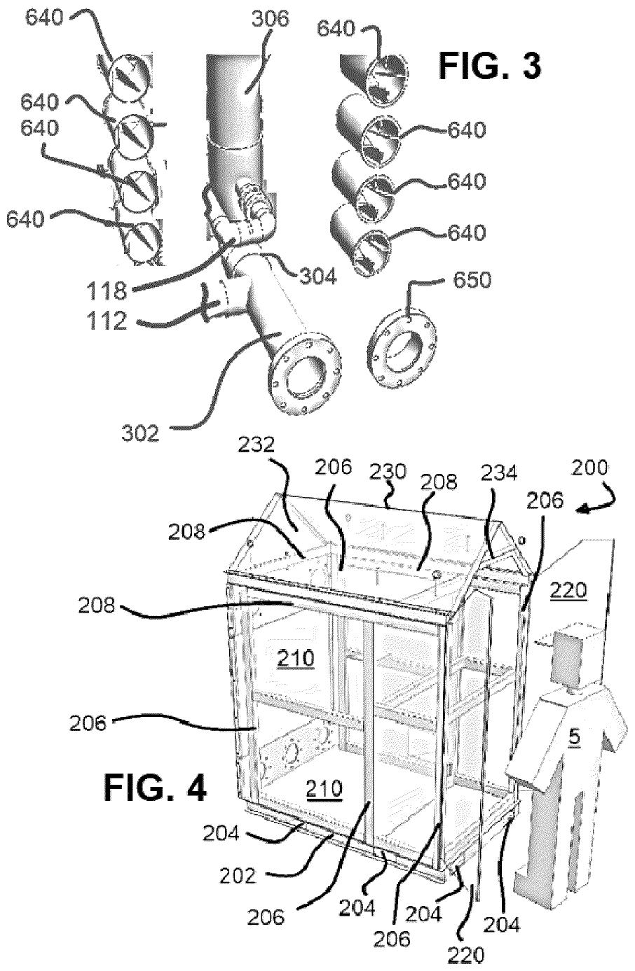

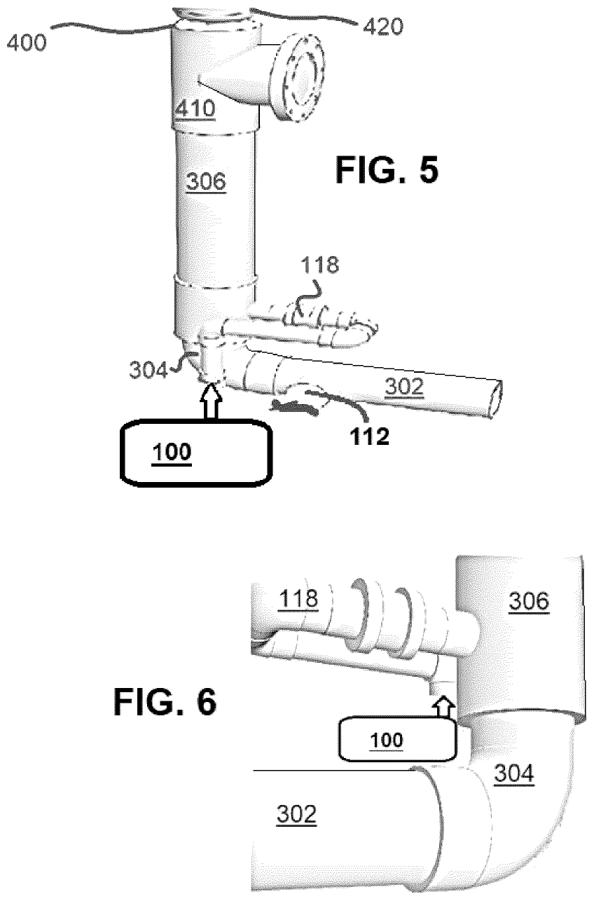

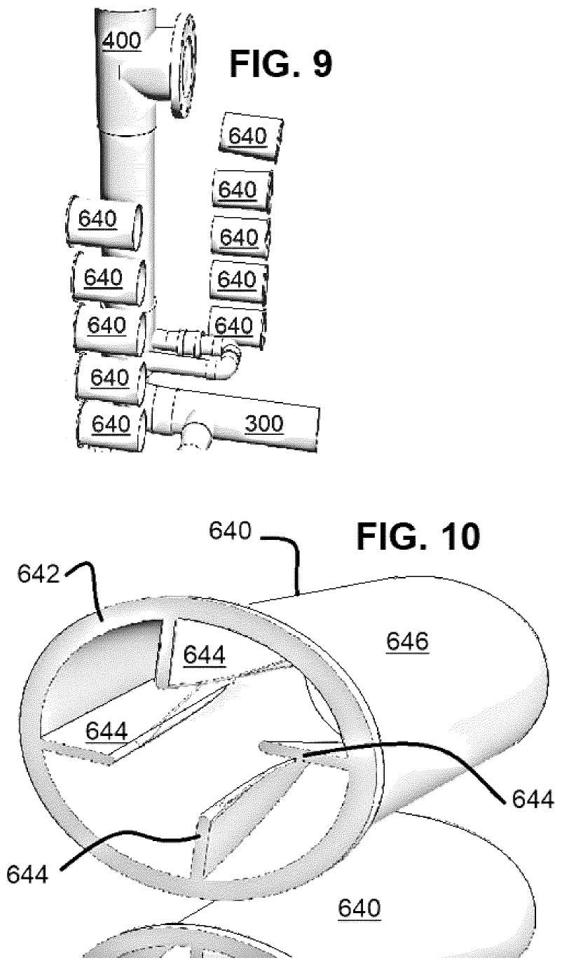

The present invention is directed a portable high capacity mixing system 1000 for pressurized flow shown in FIGS. 1-11. The portable mixing system 1000 includes a housing subsystem 200, an inlet and riser subsystem 300, an air flow management subsystem 400, a top deck subsystem 500 and a static mixer subsystem 600 with an outlet.

The portable mixing system 1000 is designed to be portable as it can be moved as a unit and has a weight of about 1,500 lbs. and the housing subsystem 200 creates a 4′×6′ footprint that fits into the bed of conventional long or standard bed length pick-up trucks (even some short bed trucks).

For reference, short bed pick-up trucks typically have a bed length of 5-6′, standard length pick-up trucks typically have a bed length of 6′ to 6.5′ and long bed trucks typically have bed 8′ in length. The width between wheel wells is conventionally 50-80″. The portable mixing system 1000 can be transported by most utility standard and long bed pick-up trucks. The housing subsystem 200 has a total height of about 7.5′ and thus on most utility pick-up trucks would yield a total height in transport of less than 12′, generally about 11′ based on the conventional truck bed height. This “transport height” is far less than the maximum legal height of 13 ft. 6 in. for trucks (semis) used in most states. Portable within the meaning of this application defines a system that i) may be moved as a single unit, ii) with a footprint not greater than 5.5′×8′, a weight less than 3000 lbs, and a total height less than 10′.

The portable mixing system 1000 is designed to be high capacity. High-capacity is defined herein that for a mixing residence or dwell time of 30 seconds a high-capacity system has a preferred flow rate of at least 250 gallons per minute. The dwell or residence time is defined herein as the average time of fluid from the fluid inlet to the outlet of the system 1000. The relevant in line subsystems of the system 1000 from the fluid inlet to the outlet have a fluid capacity of about 175 gallons such that at 350 gallons per minute speed the residence time is 30 seconds making this system 1000 a high-capacity system. It should be appreciated that some materials would not require mixing for 30 seconds and a higher operational flow rate may be implemented in the system 1000, similarly the flow rate may be lowered from 350 gallons per minute to increase the residence time in the system 1000. The 30 second residence time is utilized for evaluation and design of the system 1000 as this is an often stated or recommended mixing time requirement for many treating agents.

### Housing Subsystem 200

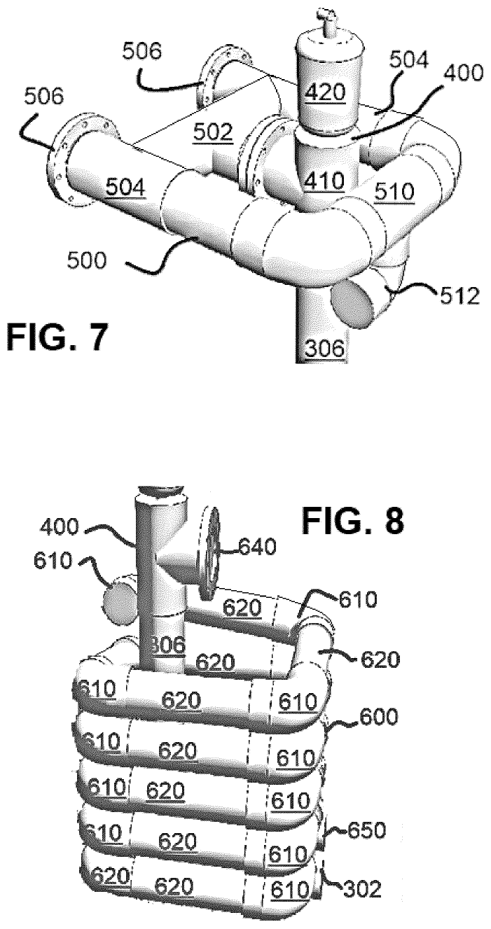

The housing subsystem 200 includes a 4′×6″ base 202 supporting the system 1000 with fork pockets 204 within each side to facilitate movement of the system 1000 and is best shown in FIG. 7. Each forklift pocket 204 is an opening in the base 202 through which a prong of a forklift is inserted, wherein a pair of prongs are inserted into a pair of pockets 204 to secure, balance and lift and transport the system 1000 safely. The prongs of the forklift may be coupled to a forklift, a front loader or skid steer or associated equipment.

The housing subsystem 200 includes frame members 206 extending about 6′ with cross supports 208 to which panels 210 may be attached. Doors 220 on the back end of the system 1000 give the user access to components within an enclosed portion 218 within the housing subsystem 220. This can include third party injection systems 100 discussed below. A schematic user 5 is shown in some of the figures for scale. Panels 210 may have access panels 222 for ease of access to select components without removing the side panels 210. Lift points 224 may be secured to the frame members 206 and/or cross supports 208, preferably at the corners, to allow for lifting of the system 1000 for movement and placement of the system 1000. The lift points 224 are exploded from the system 1000 for clarity.

The housing subsystem 200 includes an apex roof assembly 230 with roof frame members 232 and roof panels 234. The roof assembly is designed to accommodate the airflow management subsystem 400. The apex of the roof assembly 230 stands at 7′6″.

The housing assembly 200 includes an internal frame 240 supporting the top deck system 500 and the static mixing subsystem 600

### Inlet and Riser Subsystem 300

The inlet and riser subsystem 300, shown in detail in FIGS. 6 and 8, is mounted upon the base 202 and includes an inlet pipe 302 extending through one panel 210 on the “front” of the system 1000. The 6″ inlet pipe may be coupled to the outlet of a feeding pump (not shown) with any conventional attachment. Adapters may be used to attach the inlet pipe 302 of the system 1000 to other pump outlet types.

The system 1000 will often or typically be coupled to a third party injection system 100 for adding material to be mixed (dosing agent). Such systems 100 may be upstream of the system 1000 and input at or before inlet pipe 302, or may be onboard the system 1000 such as within enclosed portion 218 or coupled to the top deck subsystem 500. The third party injection subsystems may be fluid injection systems or powder injection systems, gel systems or the like. One such system 100 is a powder injection system co-invented by the inventor of this system and disclosed in U.S. Patent Application Ser. No. 63/589,808 filed Oct. 12, 2023 (U.S. Patent Publication 2025-0122104). Various material injections systems exist and do not form part of the present invention of a mixing system 1000.

A bypass feed 112 may extend from the generally horizontal inlet pipe 302, where needed for an injection system 100 (see U.S. Patent Publication 2025-0122104). The generally horizontal inlet pipe 302 extends to an elbow 304 and is coupled to an 8″ standpipe or riser 306. The 8″ standpipe or riser 306 extends vertically about 5 feet extending to the air flow management subsystem 400 which is coupled to the top deck subsystem 500. An onboard injection system 100 housed within enclosed portion 218 may inject fluid to the pressurized fluid flow within the riser 306 via system feed 118 adjacent the coupling of the elbow 304 and the riser 306. The coupling of the feed 118 to the riser 306 may be considered as the point from which the relevant residence time is measured, although the technical residence time is longer if a system 100 is used which is upstream of the mixing system 1000, and slightly less if a system is used coupled to the top deck subsystem 500.

The 6″ elbow 304 and the 8″ riser 306 creates a flash mixing type turbulent portion near this coupling which assists the mixing of the pressurized stream. The feed 118 is attached to the riser 306 adjacent the coupling of the elbow 304 and the riser 306 so as to be within the turbulent portion, however the feed 118 could also be positioned or coupled to the elbow 306 or slightly before within the inlet pipe 302. It is sufficient that the feed 118 is coupled to the main flow at, or before, the turbulent area formed by the coupling of the elbow 304 and the riser 306. The feed 118 may also have a control valve.

The dosing amount or rate from system 100 into system 1000 is selected based upon the ability to fully dose the fluid within the pressurized fluid flow within the inlet and riser subsystem 300, and will depend upon the specific fluid, dosing agent and speed of the pressurized fluid flow within the inlet and riser subsystem 300.

### An Air Flow Management Subsystem 400

The air flow management subsystem 400 is coupled to the riser 306 and to the top deck subsystem 500. The air flow management subsystem 400 includes a T-coupling 410 that receives the flow from the riser 306 and directs the flow to the top deck subsystem 500. Additionally, the t-coupling 410 is coupled to an air management unit 420. The air management unit 420 relieves excess air pressure that may occur within the system 1000 and allow inputting air during shutdown or drainage of the system 1000. Essentially the air management system 420 is at the highest point of the water treating aspects of the system 1000 generally within the roof assembly of the housing subsystem 200. Air will collect in an accumulator and will be episodically released as pressure reaches a release threshold. A float valve shutoff prevents liquid from being discharged through the air flow management unit 420. The air management system 400 also works to bring air within the system 1000, such as during draining of the system 1000.

### Top Deck Subsystem 500

The T-coupling 410 of the air flow management subsystem 400 is coupled to an 8″ diameter flow divider 502 of the top deck subsystem 500. The top deck subsystem 500 may be supported on the internal frame 240. The flow divider 502 leads to two horizontal 8″ diameter sections 504 coupled to front loading ports 506. The horizontal sections 504 lead to elbows 508 coupled to 8″ diameter merge section 510 which merges the flow into outlet elbow 512 that is coupled to the static mixer subsystem 600. The top deck subsystem may also be used as a location for introducing a dosing agent from a third party injection system 100, for example the top deck system 500 may be configured to for holding dissolvable solids installed through the loading ports 506. Liquid or powder injectors 100 could also be configured to interact with the subsystem 500 for adding dosing agents of interest.

The top deck subsystem 500 has the ability to easily receive dosing agents into the fluid flow from a system 100 to options for the mixing as some agents may be better introduced at this location.

The top deck subsystem 500 may include baffles within the horizontal sections 504. The inserted baffles (not shown) can be used to create greater mixing within the system 1000.

The inlet and riser subsystem 300 and the top deck subsystem 500 have a volume capacity of about 50 gallons with the static mixer subsystem 600 has a volume capacity of about 125 gallons.

### Static Mixer Subsystem 600

The outlet elbow 512 of the top deck system 500 reduces from 8″ diameter piping to 6″ diameter piping and is coupled to the static mixer subsystem 600. The static mixer subsystem 600 is a downward extending spiral of five loops and about 85′ pathway of 6″ diameter piping comprised of elbows 610, straight coupling segments 620 and inserted baffled segments 640. The downward extending spiral pathway of the static mixer subsystem 600 ends at the outlet 650 adjacent the inlet pipe 302. The 6″ outlet 650 may be coupled to a 6″ discharge line. The discharge line may lead to a tank, subsequent processing, a settling pond, a storm water handling system or the like depending upon the application. Adapters may be used to attach the outlet 650 of the system 1000 to a discharge line.

The static mixer subsystem 600 is mounted on the on the internal frame 240 essentially having the downward extending spiral about 85′ pathway of 6″ diameter piping wrap around the frame 240 in designated sloped shelve supports.

The spiral shape formed by the elbows 610 creates a large amount of mixing of the fluid within the static mixer subsystem 600 to the outlet 650. Additionally a plurality of and inserted baffled segments 640 are mounted within select number of straight coupling segments 620. Each inserted baffle segment includes an annular ledge 242 that abuts between the straight coupling segments 620 and an adjacent elbow 610 and a sleeve 246 sized to slide within the straight coupling segments 620. Each inserted baffle segment includes at least one internal baffle member 644 (preferably four as shown) for creating and enhancing mixing within the flow. The baffle members 244 are formed as “non-ragging” meaning they have smooth edges in the direction of flow to facilitate flow and prevent detritus within the flow from being captured and built up upon the baffle members 244 hindering flow and operation. Generally this means the baffles 244 taper against the flow such that detritus will flow along and not become trapped by the baffle members 244.

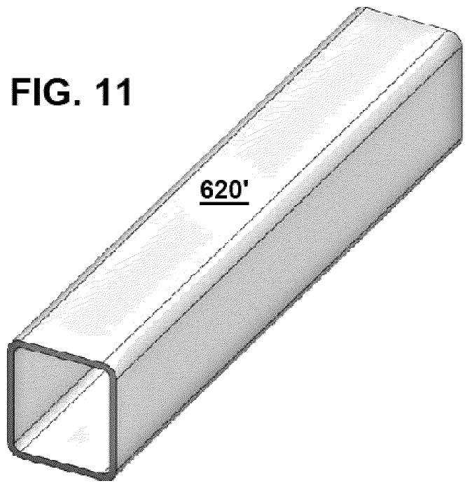

One alternative is to form the static mixer subsystem 600 with rectangular piping, with a representative straight coupling segment 620′ shown in FIG. 11. The rectangular cross sectional shape (which may be square) of the piping will improve mixing and create a better usage of space, in that there is less “wasted” space in the system 1000 with the rectangular cross sectioned piping 620′ (and complementary shaped elbows and baffle inserts).

### Operation

In operation an outlet of a feeding pump (not shown) is coupled to the inlet pipe 302 with any conventional attachment and a discharge line is coupled to the outlet 650. The desired additive is supplied via a system 100 either upstream of the system 1000 or onboard as discussed above, such as via 118 or within sections 504. It is also possibly the system 1000 injects combinations of powders, liquids and solids from more than one system 100. With the system 1000 prepared the inlet pump is turned on to provide the source of pressurized fluid and the system 1000 operates as a portable high-capacity mixing system for the pressurized fluid flow.

### Operational Examples Flocculation System

System 1000 may be particularly useful in adding powder flocking agents to water (stormwater, or other water sources) comprising effective amounts of sodium carbonite sodium bentonite (coagulant)/powder anionic polyacrylamide.

Sodium carbonate (also known as washing soda, soda ash and soda crystals) is the inorganic compound with the formula Na₂CO₃ and its various hydrates. Sodium carbonate is a water-soluble source of carbonate. The calcium and magnesium ions form insoluble solid precipitates upon treatment with carbonate ions.

Sodium bentonite is a type of absorbent swelling clay that is mostly composed of montmorillonite, a type of smectite mineral and it expands when wet, absorbing as much as several times its dry mass in water and further it exhibits excellent colloidal properties.

Polyacrylamide is a polyolefin. It can be viewed as polyethylene with amide substituents on alternating carbons. It is a widely used flocculating agent for water treatment.

The system 1000 may be coupled to an existing water treatment system (such as a settling pond) and activated via float valves when water in the existing system is too high and additional treatment is desired. Essentially a stormwater actuated system. The treated water can be returned to the existing water treatment system.

### Operational Examples Acid Mine Drainage Treatment

System 1000 may be particularly useful in rapid PH adjustment for treating acid mine drainage. In this PH adjustment application the dosing agent is Calcium Silica Aggregate. Acid mine drainage, acid and metalliferous drainage (AMD), or acid rock drainage (ARD) is the outflow of acidic water from metal mines or coal mines. Acid rock drainage occurs naturally within some environments as part of the rock weathering process but is exacerbated by large-scale earth disturbances characteristic of mining and other large construction activities, usually within rocks containing an abundance of sulfide minerals. Areas where the earth has been disturbed (e.g. construction sites, subdivisions, and transportation corridors) may create acid rock drainage. In many localities, the liquid that drains from coal stocks, coal handling facilities, coal washeries, and coal waste tips can be highly acidic, and in such cases it is treated as acid rock drainage. This liquid often contains highly toxic metals, such as copper or iron. These, combined with reduced pH, have a detrimental impact on the streams' aquatic environments.

Calcium silicate, also known as slag, is produced when molten iron is made from iron ore, silicon dioxide and calcium carbonate in a blast furnace. When this material is processed into a highly refined, re-purposed calcium silicate aggregate, it is often used in the remediation of acid mine drainage (AMD) on active and passive mine sites. Calcium silicate neutralizes active acidity in AMD systems by removing free hydrogen ions from the bulk solution, thereby increasing pH. As its silicate anion captures H⁺ ions (raising the pH), it forms monosilicic acid (H₄SiO₄), a neutral solute. Monosilicic acid remains in the bulk solution to play other important roles in correcting the adverse effects of acidic conditions. As opposed to limestone (also popular remediation material), calcium silicate effectively precipitates heavy metals and does not armor over, prolonging its effectiveness in AMD systems. The use of system 1000 to introduce calcium silicate aggregate into AMD flow allows the AMD to be effectively treated.

### Operational Examples—Blackwater Applications

System 1000 may be particularly useful in capturing pollutants within the stream. In this application the dosing agent may comprise aggregate biochar material. Biochar is the lightweight black residue, made of carbon and ashes, remaining after the pyrolysis of biomass, and is a form of charcoal. Biochar is defined by the International Biochar Initiative as “the solid material obtained from the thermochemical conversion of biomass in an oxygen-limited environment”. Biochar is a stable solid that is rich in pyrogenic carbon and can endure in soil for thousands of years. Biochar in the present implementation is a high-carbon, fine-grained residue that is produced via pyrolysis of hardwoods, such as in particular oaks, specifically red oak. It is the direct thermal decomposition of the hardwood biomass in the absence of oxygen (preventing combustion), which process produces a mixture of solids (the biochar), liquid (bio-oil), and gas (syngas) products. Gasifiers may be effectively used to form the biochar used in the present invention. The gasification process consists of four main stages: oxidation, drying, pyrolysis, and reduction. Temperature during pyrolysis in gasifiers is 250-550° C. (523-823 K), 600-800° C. (873-1,073 K) in the reduction. The biochar is granulated for application in the present process.

The present invention is designed as a portable high-capacity mixing system for pressurized flow and it may have broader application as flow controlled rapid powder injection into other pressurized flows.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A portable mixing system for pressurized flow comprising:
a portable housing including a base supporting the system;
a fluid inlet within the housing;
A fluid outlet within the housing;
a static mixer within the housing in fluid communication with the fluid inlet and the fluid outlet, the static mixer including a spiral pathway of piping extending to the fluid outlet, and
wherein the portable mixing system may be moved as a single unit, has a footprint not greater than 5.5′×8′, has a weight less than 3000 lbs, and a total height less than 10′.

2. The portable mixing system according to claim 1 wherein the static mixer further includes a plurality of baffled segments wherein each baffle segment includes at least one internal baffle member for creating and enhancing mixing within the flow.

3. The portable mixing system according to claim 2 wherein each baffle segment includes four internal baffle members.

4. The portable mixing system according to claim 2 wherein the static mixer is a downward extending spiral of five loops and about 85′ pathway of 6″ diameter piping comprised of elbows, straight coupling segments and inserted baffled segments.

5. The portable mixing system according to claim 2 wherein the housing includes an internal frame and wherein the spiral pathway of piping wraps around the internal frame.

6. The portable mixing system according to claim 2 wherein the spiral pathway of piping includes rectangular cross sectional piping.

7. The portable mixing system according to claim 1 wherein the base includes at least one set of fork pockets to facilitate movement of the system wherein each forklift pocket is an opening in the base through which a prong of a forklift is inserted.

8. The portable mixing system according to claim 1 wherein the housing includes a plurality of frame members and cross supports with panels attached thereto.

9. The portable mixing system according to claim 8 wherein the housing includes lift points secured to the frame members or cross supports configured to allow for lifting of the system.

10. The portable mixing system according to claim 8 wherein the housing includes a roof assembly with the total height of the system being less than 8′.

11. The portable mixing system according to claim 1 wherein the fluid inlet is generally horizontal and is fluidly coupled a generally vertical riser.

12. The portable mixing system according to claim 11 wherein the fluid inlet has a cross sectional area less than the cross sectional area of the vertical riser.

13. The portable mixing system according to claim 11 further including an air flow management subsystem coupled to the riser and including an air management unit configured to relieve excess air pressure that may occur within the system and to allow inputting air during shutdown or drainage of the system.

14. The portable mixing system according to claim 13 wherein the air management unit is at the highest point of the fluid handling components of the system and wherein air will collect in an accumulator and will be episodically released as pressure reaches a release threshold.

15. The portable mixing system according to claim 13 further including a top deck subsystem fluidly coupled to the riser and including at least one horizontal section fluidly coupled to the static mixer.

16. The portable mixing system according to claim 15 wherein the static mixer further includes a plurality of baffled segments wherein each baffle segment includes at least one internal baffle member for creating and enhancing mixing within the flow.

17. The portable mixing system according to claim 16 wherein each baffle segment includes four internal baffle members.

18. The portable mixing system according to claim 16 wherein the static mixer is a downward extending spiral of five loops and about 85′ pathway of 6″ diameter piping comprised of elbows, straight coupling segments and inserted baffled segments.

19. The portable mixing system according to claim 16 wherein the housing includes an internal frame and wherein the spiral pathway of piping wraps around the internal frame.

20. The portable mixing system according to claim 16 wherein the spiral pathway of piping includes rectangular cross sectional piping.
